(19) United States
(12) Patent Application Publication
(10) Pub. No.: US 2026/0331378 A1
(43) Pub. Date: Oct. 22, 2026

(54) MULTILAYER CERAMIC ELECTRONIC COMPONENT

(71) Applicant: Murata Manufacturing Co., Ltd., Nagaokakyo-shi (JP)

(72) Inventor: Kota ZENZAI, Nagaokakyo-shi (JP)

(21) Appl. No.: 19/711,507

(22) Filed: Jun. 17, 2026

Related U.S. Application Data
(63) Continuation of application No. PCT/JP2024/030943, filed on Aug. 29, 2024.

(30) Foreign Application Priority Data
Dec. 27, 2023 (JP) 2023-220468

(51) Int. Cl. H01G 4/30; H01G 4/008; H01G 4/12; H01G 4/232

(52) U.S. Cl. CPC H01G 4/30; H01G 4/008; H01G 4/1209; H01G 4/2325

(57) ABSTRACT

In a multilayer ceramic electronic component, a first outer electrode includes a first main surface band portion, a second outer electrode includes a second main surface band portion, the first outer electrode includes a first spacer portion on the first main surface band portion, and the second outer electrode includes a second spacer portion on the second main surface band portion, the first spacer portion and the second spacer portion include an electroconductive material, and the multilayer ceramic electronic component includes a first insulating layer continuously covering a first connection portion, a first side surface band portion, and a third side surface band portion, and a second insulating layer continuously covering a second connection portion, a second side surface band portion, and a fourth side surface band portion.

### CROSS REFERENCE TO RELATED APPLICATIONS

This application claims the benefit of priority to Japanese Patent Application No. 2023-220468 filed on Dec. 27, 2023 and is a Continuation Application of PCT Application No. PCT/JP 2024/030943 filed on Aug. 29, 2024. The entire contents of each application are hereby incorporated herein by reference.

### BACKGROUND OF THE INVENTION

### 1. Field of the Invention

The present invention relates to multilayer ceramic electronic components.

### 2. Description of the Related Art

Examples of a multilayer ceramic electronic component include a multilayer ceramic capacitor. A multilayer ceramic capacitor including a laminated dielectric layer, an internal electrode disposed to face the laminated dielectric layer, and an outer electrode connected to the internal electrode is needed to normally operate electronic devices such as a mobile phone, a personal computer, or a medical device. As a dielectric substance of a dielectric layer in the multilayer ceramic capacitor, a dielectric ceramic with a perovskite structure such as barium titanate is normally used. Thus, when an alternating-current voltage is applied while a direct-current voltage is applied, vibrations occur due to a piezoelectric phenomenon. When a multilayer ceramic capacitor is mounted on a mounting board and an alternating-current voltage within a human audible range within, for example, a range from 20 Hz to 20000 Hz is applied to an outer electrode, the multilayer ceramic capacitor causes stretching vibrations. The vibrations cause sounds, a wiring mounting board also resonates with the sounds, and the sounds are amplified to cause a noise. This noise is annoying to people. To solve such a noise, for example, Japanese Patent Application No. 2019-86320 describes a technology of a multilayer ceramic capacitor additionally including a first bump and a second bump. The first bump and the second bump described in Japanese Patent Application No. 2019-86320 include a gap to reduce the height of solder wetting.

However, the technology described in Japanese Patent Application No. 2019-86320 involves a process for forming a multilayer ceramic capacitor and a process for forming a first bump and a second bump, and thus involves complex manufacturing processes at high manufacturing costs.

### SUMMARY OF THE INVENTION

Example embodiments of the present invention provide multilayer ceramic electronic components each manufactured using less complex processes at lower manufacturing costs, while significantly reducing noise generation.

A multilayer ceramic electronic component according to an example embodiment of the present invention includes a multilayer body including a plurality of dielectric layers laminated on each other, a first main surface and a second main surface opposite to each other in a height direction, a first side surface and a second side surface opposite to each other in a width direction perpendicular or substantially perpendicular to the height direction, a first end surface and a second end surface opposite to each other in a length direction perpendicular or substantially perpendicular to the height direction and the width direction, a first internal electrode laminated alternately with the plurality of dielectric layers and exposed on the first end surface, and a second internal electrode laminated alternately with the plurality of dielectric layers and exposed on the second end surface; a first outer electrode connected to the first internal electrode; and a second outer electrode connected to the second internal electrode, wherein the first outer electrode includes a first connection portion on the first end surface, a first main surface band portion on the first main surface, a third main surface band portion on the second main surface, a first side surface band portion on a portion of the first side surface, a third side surface band portion on a portion of the second side surface, and a first spacer portion on the first main surface band portion, the second outer electrode includes a second connection portion on the second end surface, a second main surface band portion on the first main surface, a fourth main surface band portion on the second main surface, a second side surface band portion on a portion of the first side surface, a fourth side surface band portion on a portion of the second side surface, and a second spacer portion on the second main surface band portion, the first spacer portion and the second spacer portion include an electroconductive material, and the multilayer ceramic electronic component includes a first insulating layer continuously covering the first connection portion, the first side surface band portion, and the third side surface band portion, and a second insulating layer continuously covering the second connection portion, the second side surface band portion, and the fourth side surface band portion.

According to example embodiments of the present invention, multilayer ceramic electronic components each manufactured using less complex processes at lower manufacturing costs, while significantly reducing noise generation are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram of a multilayer ceramic capacitor according to a first example embodiment of the present invention.

FIG. 2 is a cross-sectional view taken along line 201-201 in FIG. 1.

FIG. 3 is a cross-sectional view taken along line 202-202 in FIG. 1.

FIG. 4 is a cross-sectional view taken along line 203-203 in FIG. 1.

FIG. 5 is a diagram of a multilayer ceramic capacitor with another structure according to an example embodiment of the present invention.

FIG. 6 is a diagram of a multilayer ceramic capacitor according to a second example embodiment of the present invention.

FIG. 7 is a diagram of a multilayer ceramic capacitor according to a second example embodiment of the present invention.

FIG. 8 is a diagram of an outer electrode according to a modified example of an example embodiment of the present invention, and corresponds to FIG. 2.

FIG. 9 is a diagram of an outer electrode according to a modified example of an example embodiment of the present invention, and corresponds to FIG. 3.

FIG. 10 is a diagram of an outer electrode according to a modified example of an example embodiment of the present invention, and corresponds to FIG. 4.

FIG. 11 is a diagram of a multilayer ceramic capacitor mounted on a mounting board according to an example embodiment of the present invention.

### DETAILED DESCRIPTION OF THE EXAMPLE EMBODIMENTS

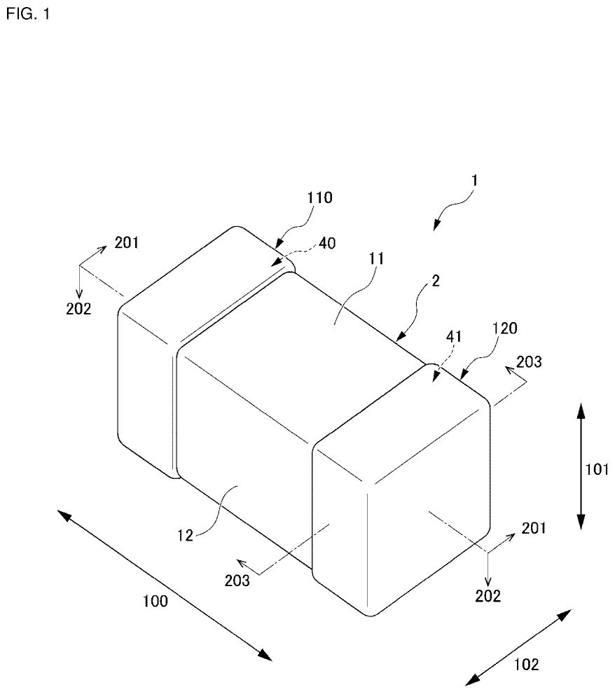

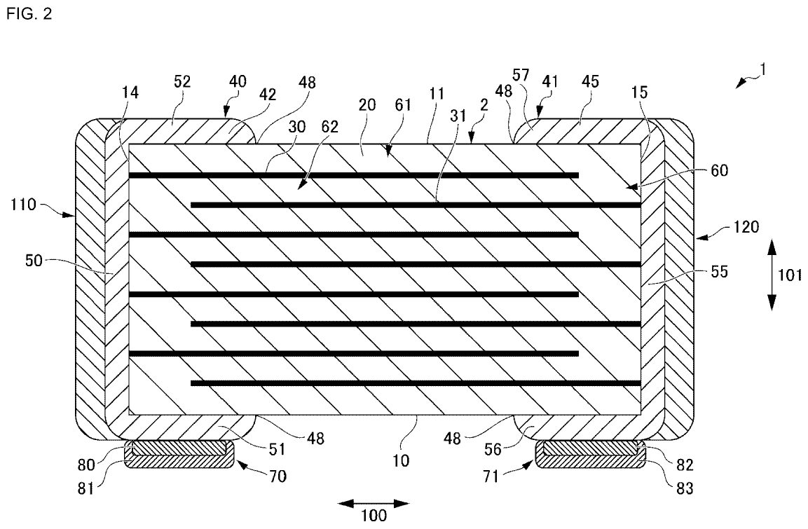

Example embodiments of the present invention are described in detail below with reference to the drawings. Hereafter, a multilayer ceramic electronic component including a multilayer ceramic capacitor 1 is described as an example. FIG. 1 is a perspective view of a multilayer ceramic capacitor 1 according to a first example embodiment of the present invention. FIG. 2 is a cross-sectional view taken along line 201-201 in FIG. 1.

The multilayer ceramic capacitor 1 includes a multilayer body 2 and outer electrodes. The outer electrodes include a first outer electrode 40 and a second outer electrode 41. Each outer electrode is covered with an insulating layer. The first outer electrode 40 is covered with a first insulating layer 110. The second outer electrode 41 is covered with a second insulating layer 120. The first outer electrode 40 and the second outer electrode 41 are covered with the insulating layers, and thus are not exposed on the surface of the multilayer ceramic capacitor 1 in FIG. 1.

As illustrated in FIG. 2, the multilayer body 2 includes multiple laminated dielectric layers 20 and internal electrodes laminated one on another. The internal electrodes include first internal electrodes 30 and second internal electrodes 31.

The multilayer body 2 has a rectangular or substantially rectangular prism shape. Each line in the rectangular or substantially rectangular prism at which two surfaces intersect is referred to as a ridgeline. Each portion in the rectangular or substantially rectangular prism at which three surfaces intersect is referred to as a corner portion.

A direction in which the laminated dielectric layers and the internal electrodes are laminated on each other is referred to as a height direction 101, a direction perpendicular or substantially perpendicular to the height direction and in which the first outer electrode and the second outer electrode face each other is referred to as a length direction 100, and a direction perpendicular or substantially perpendicular to the height direction 101 and the length direction 100 is referred to as a width direction 102.

Of the surfaces of the multilayer body 2, two surfaces opposite to each other in the height direction 101 are referred to as a first main surface 10 and a second main surface 11, two surfaces opposite to each other in the width direction 102 are referred to as a first side surface 12 and a second side surface 13, and two surfaces opposite to each other in the length direction 100 are referred to as a first end surface 14 and a second end surface 15.

The internal electrodes include the first internal electrodes 30 and the second internal electrodes 31. The first internal electrodes 30 are exposed on the first end surface 14. The second internal electrodes 31 are exposed on the second end surface 15.

A portion in which the multiple dielectric layers 20 and multiple internal electrodes are laminated is referred to as an inner layer portion 60. The first internal electrodes 30 and the second internal electrodes 31 are disposed on different dielectric layers 20.

The dielectric layers 20 are made of a dielectric material. Examples of a dielectric material include dielectric ceramics including a component of, for example, barium titanate, calcium titanate, strontium titanate, or calcium zirconate. The dielectric material includes dielectric ceramics as a main component, and may include a subcomponent. Examples of a subcomponent include, for example, a manganese compound, an iron compound, a chromium compound, a cobalt compound, or a nickel compound.

The thickness of the dielectric layers 20 is not limited to a particular thickness. An area generating a capacitance defined by the first internal electrodes 30 and the second internal electrodes 31 is referred to as an effective area 62. The thickness of the dielectric layers 20 in the effective area 62 is, for example, greater than or equal to about 0.3 μm and less than or equal to about 2.0 μm.

The number of the dielectric layers 20 is not limited to a particular number. The number of the dielectric layers 20 in the effective area 62 is, for example, greater than or equal to one and less than or equal to 6000.

On both sides of the inner layer portion 60 in the height direction 101, portions including simply the dielectric layers 20 without including internal electrodes are referred to as outer layer portions 61. The thickness of the outer layer portions 61 is not limited to a particular thickness. The thickness of the outer layer portions 61 is, for example, greater than or equal to about 15 μm and less than or equal to about 150 μm.

The thickness of the dielectric layers 20 in the outer layer portions 61 may be greater than the thickness of the dielectric layers 20 in the effective area 62. The material of the dielectric layers 20 in the outer layer portions 61 may differ from the material of the dielectric layers 20 in the inner layer portion 60.

The outer electrodes include the first outer electrode 40 and the second outer electrode 41. The first outer electrode 40 is an outer electrode connected to the first internal electrodes 30. The second outer electrode 41 is an outer electrode connected to the second internal electrodes 31.

Each outer electrode disposed on the end surface is referred to as a connection portion. The outer electrode disposed on the side surface and an extension surface of the side surface extended in the length direction is referred to as a side surface band portion. The outer electrode disposed on the main surface and an extension surface of the main surface extended in both the length direction and the width direction is referred to as a main surface band portion.

The first outer electrode 40 includes a first connection portion 50 disposed on the first end surface 14, a first main surface band portion 51 disposed on the first main surface 10, a third main surface band portion 52 disposed on the second main surface 11, a first side surface band portion 53 disposed on a portion of the first side surface 12, and a third side surface band portion 54 disposed on a portion of the second side surface 13.

The second outer electrode 41 includes a second connection portion 55 disposed on the second end surface 15, a second main surface band portion 56 disposed on the first main surface 10, a fourth main surface band portion 57 disposed on the second main surface 11, a second side surface band portion 58 disposed on a portion of the first side surface 12, and a fourth side surface band portion 59 disposed on a portion of the second side surface 13.

The outer electrodes include base electrode layers. The base electrode layers are layers including electroconductive metal and glass. The base electrode layer included in the first outer electrode 40 is referred to as a first base electrode layer 42. The base electrode layer included in the second outer electrode 41 is referred to as a second base electrode layer 45.

The base electrode layers include at least one material of, for example, a fired layer, an electroconductive resin layer, or a thin film layer. Preferably, the fired layer includes either one or both of a metal component and at least one of a glass component and a ceramic component. Examples of the metal component include at least one of, for example, copper, nickel, silver, palladium, a silver-palladium alloy, or gold. Examples of the glass component include at least one of, for example, boron, silicon, barium, magnesium, aluminum, or lithium. The ceramic component may be the same material as the dielectric layers 20. The ceramic component may be a different material from the dielectric layers 20. Examples of the ceramic component include at least one of, for example, barium titanate, calcium titanate, calcium barium titanate, strontium titanate, or calcium zirconate.

The fired layer is formed by applying, for example, electroconductive paste including glass and metal to the multilayer body 2, and then firing the electroconductive paste. The fired layer may be formed by concurrently firing a multilayer chip including the internal electrode and the dielectric layers 20 and the electroconductive paste applied to the multilayer chip. Alternatively, for example, the fired layer may be formed by firing a multilayer chip including the internal electrode and the dielectric layers 20 to obtain the multilayer body 2, and then applying the electroconductive paste to the multilayer body 2 and firing the electroconductive paste.

To concurrently fire a multilayer chip including the internal electrode and the dielectric layers 20 and the electroconductive paste applied to the multilayer chip, the fired layer is preferably formed by, for example, firing the electroconductive paste additionally including a ceramic material instead of a glass component. In this case, as a ceramic material to be added, the same ceramic material as the dielectric layers 20 is particularly preferably used. Instead of a single fired layer, multiple fired layers may be included.

The thickness of the first base electrode layer 42, in the length direction 100, positioned on the first end surface 14 is preferably, for example, greater than or equal to about 3 μm and less than or equal to about 160 μm at a center portion of the first base electrode layer 42 in the height direction 101 and the width direction 102. The thickness of the second base electrode layer 45, in the length direction 100, positioned on the second end surface 15 is preferably, for example, greater than or equal to about 3 μm and less than or equal to about 160 μm at a center portion of the second base electrode layer 45 in the height direction 101 and the width direction 102.

Each outer electrode may include a plating layer in addition to the base electrode layer. The structure of the outer electrode including a plating layer is described later.

The multilayer ceramic capacitor 1 according to the present example embodiment includes spacer portions including electroconductive metal as portions of the outer electrodes. The spacer portions include a first spacer portion 70 and a second spacer portion 71. The first main surface band portion 51 includes the first spacer portion 70. The second main surface band portion 56 includes the second spacer portion 71.

The spacer portions are portions of components in the outer electrodes. When the multilayer ceramic capacitor 1 is mounted on, for example, a mounting board, the spacer portions disposed between components can increase the distance between the multilayer body and the mounting board.

The spacer portions include an electroconductive material. Preferably, the spacer portions include metal plating. The spacer portions including metal plating can be observed in the manner described below. In a cross section taken along a plane parallel or substantially parallel to the length direction 100 and the height direction 101 at the center portion in the width direction 102, glass contents of the first main surface band portion 51, the second main surface band portion 56, the first spacer portion 70, and the second spacer portion 71 are measured. When the glass contents of the first spacer portion 70 and the second spacer portion 71 are smaller than the glass contents of the first main surface band portion 51 and the second main surface band portion 56, the spacer portions are determined to include metal plating.

The material of the spacer portions is not limited to metal plating. The spacer portions may include, for example, electroconductive paste. The spacer portions may include, for example, blocks formed from an electroconductive material.

The shape of the spacer portions is not limited to a particular one. Examples of the shape of the spacer portions include a rectangular or substantially rectangular prism shape, a cylindrical or substantially cylindrical shape, and a solid with a H-shaped bottom surface.

The first spacer portion 70 is disposed at at least the first main surface band portion 51, and covers a portion of the first base electrode layer 42 disposed at a portion of the first main surface. The second spacer portion 71 is disposed at at least the second main surface band portion 56, and covers a portion of the second base electrode layer 45 disposed at a portion of the first main surface.

Thus, plating layers defining and functioning as the spacer portions are provided on the first main surface band portion 51 and the second main surface band portion 56. When the multilayer ceramic capacitor 1 is mounted on, for example, a mounting board, the multilayer body and the mounting board can be spaced apart from each other by the thickness of the spacer portions, and thus the height of solder wetting can be reduced. Thus, noise generation resulting from electrostrictive strain can be reduced.

The first spacer portion 70 may extend from the first main surface band portion 51 to a portion of the first connection portion 50 to cover the first base electrode layer 42. The second spacer portion 71 may extend from the second main surface band portion 56 to a portion of the second connection portion 55 to cover the second base electrode layer 45.

This structure has an advantageous effect of improving bonding strength between the spacer portions and the base electrodes while reducing the noise generation.

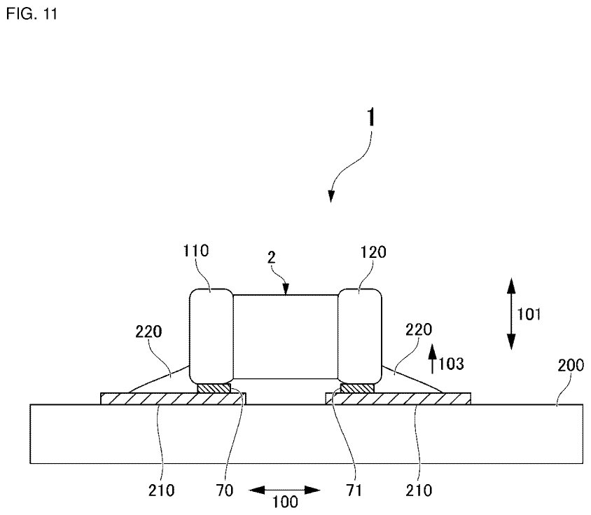

With reference to FIG. 11, mounting of the multilayer ceramic capacitor 1 on a mounting board 200 is described. FIG. 11 is a diagram of the multilayer ceramic capacitor 1 mounted on the mounting board 200. The mounting board 200 includes pads 210. The multilayer ceramic capacitor 1 is mounted on the mounting board 200 while the first spacer portion 70 and the second spacer portion 71 are electrically connected to the pads 210. Solder 220 is used for mounting. During mounting, solder wets up in the height direction 101 from the surfaces of the pads 210 (refer to arrow 103 in FIG. 11, and the direction of arrow 103 is referred to as a wetting direction). In the example embodiment illustrated in FIG. 11, the multilayer ceramic capacitor 1 can reduce the height of the solder at the connection portion and the side surface band portion in the wetting direction 103. This structure can thus reduce noise generation caused by electrostrictive strain.

In the multilayer ceramic capacitor 1 according to the present example embodiment, the spacer portions include metal plating, and the manufacturing processes are not complex. This structure can thus reduce increase in manufacturing costs caused by complex manufacturing processes.

Portions at the ends of the first main surface 10, the second main surface 11, the first side surface 12, and the second side surface 13 of each outer electrode are referred to as end portions 48 of the outer electrode. FIG. 2 illustrates, as the end portions 48 of each outer electrode, the end portion 48 of the first outer electrode 40 on the first main surface 10, the end portion 48 of the first outer electrode 40 on the second main surface 11, the end portion 48 of the second outer electrode 41 on the first main surface 10, and the end portion 48 of the second outer electrode 41 on the second main surface 11. The spacer portions may cover the end portions 48 of each outer electrode or do not have to cover the end portions 48 of each outer electrode.

The thickness of the first spacer portion 70 disposed on the first connection portion 50 may be smaller than the thickness of the first spacer portion 70 disposed on the first main surface band portion 51. The thickness of the second spacer portion 71 disposed on the second connection portion 55 may be smaller than the second spacer portion 71 disposed on the second main surface band portion 56. As described above, this structure can also reduce noise generation caused by electrostrictive strain.

Preferably, the thickness of the first spacer portion 70 disposed on the first connection portion 50 and the second spacer portion 71 disposed on the second connection portion 55 may be 0 μm. In other words, for example, no first spacer portion 70 may be disposed on the first connection portion 50, and no second spacer portion 71 may be disposed on the second connection portion 55.

Even in this case, plating layers are provided as the spacer portions at the main surface band portion. Although solder wets up to the spacer portions disposed on the main surface band portion during mounting, solder is less likely to wet up to the connection portions. Thus, in the multilayer ceramic capacitor 1 according to the present example embodiment, solder is less likely to wet up to the connection portions. Thus, an increase of the solder wetting height in the height direction 101 during mounting can be reduced, and noise generation can be reduced.

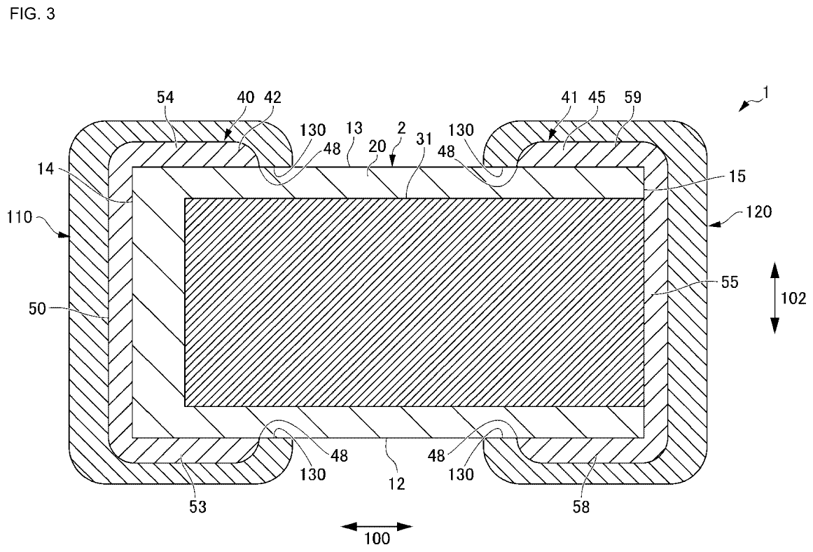

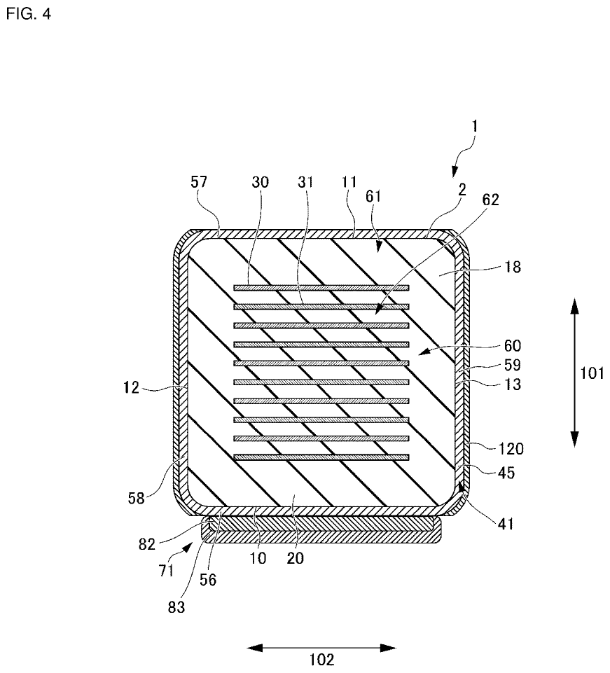

With reference to FIG. 3 and FIG. 4, the structure of the multilayer ceramic capacitor 1 viewed in other directions is described. FIG. 3 is a cross-sectional view taken along line 202-202 in FIG. 1. FIG. 4 is a cross-sectional view taken along line 203-203 in FIG. 1.

As illustrated in FIG. 3, each insulating layer covers the side surface band portion in addition to the connection portion. The first insulating layer 110 covers the first side surface band portion 53 and the third side surface band portion 54. The second insulating layer 120 covers the second side surface band portion 58 and the fourth side surface band portion 59. Each insulating layer extends beyond the end portions 48 of the outer electrode to be in contact with the side surfaces.

FIG. 3 is a cross-sectional view at the height where the second internal electrodes 31 are observable. In a cross-sectional view at another height, the first internal electrodes 30 are observable instead of the second internal electrodes 31.

As illustrated in FIG. 4, the second spacer portion 71 is disposed on the second main surface band portion 56. The second insulating layer 120 is disposed on the second side surface band portion 58 and the fourth side surface band portion 59.

The spacer portions including metal plating are now described. Metal plating may include at least one material of, for example, copper, nickel, tin, silver, palladium, a silver-palladium alloy, or gold. Instead of a single first spacer portion 70 and a single second spacer portion 71, multiple first spacer portions 70 and multiple second spacer portions 71 may be included.

Preferably, the first spacer portion 70 includes, for example, a first nickel plating layer 80 including nickel and connected to the first main surface band portion 51, and a first tin plating layer 81 including tin and covering the first nickel plating layer 80. Preferably, the second spacer portion 71 includes a second nickel plating layer 82 including nickel and connected to the second main surface band portion 56, and a second tin plating layer 83 including tin and covering the second nickel plating layer 82.

When each spacer portion includes, for example, a nickel plating layer and a tin plating layer, the nickel plating layer prevents the first base electrode layer 42 or the second base electrode layer 45 from being eroded by solder when the multilayer ceramic capacitor 1 is being mounted.

The tin plating layer improves solder wettability when the multilayer ceramic capacitor 1 is being mounted. Improvement of solder wettability facilitates mounting of the multilayer ceramic capacitor 1.

This structure includes the spacer portions including the plating layers, and thus does not involve an additional process. This structure can thus be manufactured using less complex processes at lower manufacturing costs.

The thickness of the first spacer portion 70 and the thickness of the second spacer portion 71 disposed on the main surface band portions may be, for example, greater than or equal to about 5 μm and less than or equal to about 25 μm. The thickness of each spacer portion can be detected in the method described below, for example. In a cross section taken along a plane parallel or substantially parallel to the length direction 100 and the height direction 101 at a center portion in the width direction 102, the dimension of an area, in the height direction 101, in which the metal plating is provided is measured. Thus, the thickness of the spacer portions can be observed.

When the thickness of each spacer portion is within the above range, solder is less likely to wet up when the multilayer ceramic capacitor 1 is being mounted on, for example, a mounting board, because the connection portion and the side surface band portion are physically spaced apart from the mounting board although the solder wets up to the spacer portion disposed on the main surface band portion. Thus, in the multilayer ceramic capacitor 1 according to the present example embodiment, solder is less likely to wet up to the connection portions and the side surface band portions. This structure can reduce an increase of solder wetting height in the height direction 101 during mounting, and noise generation can be reduced. When the thickness of the spacer portions is, for example, less than about 5 μm, solder is less likely to wet and a mounting failure occurs. When the thickness of the spacer portions exceeds about 25 μm, for example, the processing consumes time, and increases processing costs.

When the first insulating layer 110 is disposed on the first main surface band portion 51, the first spacer portion 70 may protrude from the first insulating layer 110 disposed on the first main surface band portion 51. When the second insulating layer 120 is disposed on the second main surface band portion 56, the second spacer portion 71 may protrude from the second insulating layer 120 disposed on the second main surface band portion 56. In other words, in a cross section taken in the length direction and the height direction, the thickness of the first spacer portion 70 and the second spacer portion 71 may be greater than that of the first insulating layer 110 and the second insulating layer 120 disposed on the band portions on the first main surface 10 and the second main surface 11.

When each spacer portion protrudes from the insulating layer, regardless of when the first insulating layer 110 is disposed on the first main surface band portion 51 or when the second insulating layer 120 is disposed on the second main surface band portion 56, solder can be easily applied to the first spacer portion 70 and the second spacer portion 71. Thus, the multilayer ceramic capacitor 1 can be easily mounted on, for example, a mounting board.

When the first insulating layer 110 is disposed on the first main surface band portion 51, the first spacer portion 70 and the first insulating layer 110 disposed on the first main surface band portion 51 may be flat. When the second insulating layer 120 is disposed on the second main surface band portion 56, the second spacer portion 71 and the second insulating layer 120 disposed on the second main surface band portion 56 may be flat. In other words, the thickness of the first spacer portion 70 and the second spacer portion 71 may be equal or substantially equal to the thickness of the first insulating layer 110 and the second insulating layer 120 disposed on the band portions on the first main surface 10 and the second main surface 11.

When the first insulating layer 110 is disposed on the first main surface band portion 51, the first spacer portion 70 may be recessed from the first insulating layer 110 disposed on the first main surface band portion 51. When the second insulating layer 120 is disposed on the second main surface band portion 56, the second spacer portion 71 may be recessed from the second insulating layer 120 disposed on the second main surface band portion 56. In other words, the thickness of the first spacer portion 70 and the second spacer portion 71 may be smaller than the thickness of the first insulating layer 110 and the second insulating layer 120 disposed on the band portions on the first main surface 10 and the second main surface 11. When each spacer portion is recessed from the insulating layer, plating cost can be reduced.

Preferably, the difference in the dimension in the height direction 101 between the first spacer portion 70 and the first insulating layer 110 is, for example, greater than or equal to about −15 μm and less than or equal to about 24 μm. Preferably, the difference in the dimension in the height direction 101 between the second spacer portion 71 and the second insulating layer 120 is, for example, greater than or equal to about −15 μm and less than or equal to about 24 μm. The difference in the dimension can be observed in the manner described below. In a cross section taken along a plane parallel or substantially parallel to the length direction 100 and the height direction 101 at a center portion in the width direction 102, a maximum dimension, in the height direction 101, of an area where the plating metal is disposed, or more specifically, the thickness of the first spacer portion 70 and the second spacer portion 71 is measured. In the first insulating layer 110 and the second insulating layer 120 disposed on the band portions on the first main surface 10 and the second main surface 11 and positioned closest to the first spacer portion 70 and the second spacer portion 71, the dimensions of the first insulating layer 110 and the second insulating layer 120 in the height direction 101, or more specifically, the thickness of the first insulating layer 110 and the second insulating layer 120 is measured. The difference in the thickness between the first spacer portion 70 and the second spacer portion 71 and the first insulating layer 110 and the second insulating layer 120 can be calculated by subtracting the thickness of the first insulating layer 110 and the second insulating layer 120 from the thickness of the first spacer portion 70 and the second spacer portion 71. Thus, the difference in the thickness between the first spacer portion 70 and the second spacer portion 71 and the insulating layers can be observed.

The above structure enables the multilayer ceramic capacitor 1 to be more easily mounted on a mounting board. When the difference in the thickness between the spacer portions and the insulating layers is less than about −15 μm, the multilayer ceramic capacitor 1 is less easily mounted, and is more likely to be detached from the mounting board. When the difference in the thickness between the spacer portions and the insulating layers exceeds about 24 μm, the dimension of the entirety of the multilayer ceramic capacitor in the lamination direction is increased, and the multilayer ceramic capacitor 1 interferes with other components when mounted, and thus the mounting performance is not preferable. In addition, plating increases the costs.

The first spacer portion 70 and the second spacer portion 71 according to the present example embodiment are made of, for example, a nickel plating layer and a tin plating layer. Preferably, the thickness of the nickel plating layer of the first spacer portion 70 and the thickness of the nickel plating layer of the second spacer portion 71 may be greater than the thickness of the tin plating layer. The thickness of the nickel plating layer may be, for example, greater than or equal to about ten times the thickness of the tin plating layer.

During mounting, the tin plating layer is eroded by solder. Thus, when the thickness of the nickel plating layer is greater than the thickness of the tin plating layer, the height of the multilayer ceramic capacitor 1 during mounting is greater than in a structure where the thickness of the nickel plating layer is less than or equal to the thickness of the tin plating layer.

In this case, solder is less likely to wet up to the connection portions or the side surface band portions. This structure can thus improve noise reduction. In addition, this structure includes the spacer portions made of the plating layers, and thus does not involve an additional process. This structure can thus be manufactured using less complex processes at lower manufacturing costs.

Preferably, the thickness of the nickel plating layer of the first spacer portion 70 may be greater than the thickness of the first insulating layer 110 disposed at the main surface band portion. Preferably, the thickness of the nickel plating layer of the second spacer portion 71 may be greater than the thickness of the second insulating layer 120 disposed at the main surface band portion.

During mounting, the tin plating layer is eroded by solder. When the thickness of the nickel plating layer is greater than the thickness of the insulating layer disposed on the main surface band portion, the nickel plating layer and the mounting board are reliably connected during mounting, and thus the conductivity is improved.

The internal electrodes are described below. As illustrated in FIG. 3, each internal electrode extends in the length direction 100, and has a rectangular or substantially rectangular shape when viewed in plan in the height direction 101. The first internal electrodes 30 extend to the first end surface 14 of the multilayer body 2. The second internal electrodes 31 extend to the second end surface 15 of the multilayer body 2. FIG. 3 illustrates one of the second internal electrodes 31.

The internal electrodes include the first internal electrodes 30 and the second internal electrodes 31. The first internal electrodes 30 and the second internal electrodes 31 are disposed on different dielectric layers 20.

The internal electrodes are formed by, for example, firing electroconductive paste on the dielectric layers. The electroconductive paste includes, for example, metal powder to be formed into an electroconductive member, an organic solvent, a binder, and a dispersing agent. The internal electrodes and the dielectric layers 20 are alternately laminated to form the inner layer portion 60.

As a material of the internal electrodes, for example, a metal such as nickel, copper, silver, palladium, a silver-palladium alloy, or gold may be used. Each of these metals may be an alloy of a compound including any of these metal elements and another metal.

The thickness of the internal electrodes is not limited to a particular thickness. The thickness of the internal electrodes may be, for example, greater than or equal to about 0.3 μm and less than or equal to about 1.5 μm.

The insulating layers are described below. The first insulating layer 110 continuously covers the first connection portion 50, the first side surface band portion 53, and the third side surface band portion 54. The second insulating layer 120 continuously covers the second connection portion 55, the second side surface band portion 58, and the fourth side surface band portion 59. In other words, the first insulating layer 110 is disposed over an area from the first connection portion 50 to the first side surface band portion 53 and the third side surface band portion 54. The second insulating layer 120 is disposed over an area from the second connection portion 55 to the second side surface band portion 58 and the fourth side surface band portion 59.

When the insulating layers are disposed over the connection portions, the height of solder wetting up to the connection portions can be reduced during mounting. This structure can thus reduce noise. The side surface band portions are also covered with the insulating layers, and thus solder wetting up to the side surface band portions can be reduced during mounting. Solder wetting up to the side surfaces can be reduced, and this structure can thus further reduce noise.

The first insulating layer 110 may be in contact with or not in contact with the first spacer portion 70. The second insulating layer 120 may be in contact with or not in contact with the second spacer portion 71.

The thickness of the first insulating layer 110 disposed the connection portion and the thickness of the second insulating layer 120 disposed on the connection portion may be, for example, greater than or equal to about 1 μm and less than or equal to about 20 μm. The thickness of the first insulating layer 110 disposed on the main surface band portion and the thickness of the second insulating layer 120 disposed on the main surface band portion may be, for example, greater than or equal to about 1 μm and less than or equal to about 20 μm. The thickness of the first insulating layer 110 disposed on the side surface band portions and the thickness of the second insulating layer 120 disposed on the side surface band portions may be, for example, greater than or equal to about 1 μm and less than or equal to about 20 μm.

The thickness of the insulating layers can be measured in the manner described below, for example. To measure the thickness of the insulating layers disposed on the connection portions, a cross section taken along a plane parallel or substantially parallel to the length direction 100 and the height direction 101 at the center portion in the width direction 102 is observed using a microscope, and the thickness of the insulating layers disposed on the connection portions at that time is measured in the length direction 100.

To measure the thickness of the insulating layers disposed on the side surface band portions, a cross section taken along a plane parallel or substantially parallel to the length direction 100 and the width direction 102 at the center portion in the height direction 101 is observed using a microscope, and the thickness of the insulating layers disposed on the side surface band portions at that time is measured in the length direction 100.

To measure the thickness of the insulating layers disposed on the main surface band portions, a cross section taken along a plane parallel or substantially parallel to the length direction 100 and the height direction 101 at the center portion in the width direction 102 is observed using a microscope, and the thickness of the insulating layers disposed on the main surface band portions at that time is measured in the height direction 101.

The first insulating layer 110 may continuously cover the first connection portion 50, the first side surface band portion 53, a portion of the first side surface 12 exposed on the surface of the multilayer ceramic capacitor 1, the third side surface band portion 54, and a portion of the second side surface 13 exposed on the surface of the multilayer ceramic capacitor 1. The second insulating layer 120 may continuously cover the second connection portion 55, the second side surface band portion 58, a portion of the first side surface 12 exposed on the surface of the multilayer ceramic capacitor 1, the fourth side surface band portion 59, and a portion of the second side surface 13 exposed on the surface of the multilayer ceramic capacitor 1.

Portions of each insulating layer covering the side surfaces exposed on the surfaces of the multilayer ceramic capacitor 1 are referred to as insulating layer side surface portions 130. As illustrated in FIG. 3, the insulating layer side surface portions 130 cover end portions 48 of the corresponding outer electrodes.

Preferably, the first insulating layer 110 may cover the entireties or substantially the entireties of the first connection portion 50, the first side surface band portion 53, and the third side surface band portion 54. Preferably, the second insulating layer 120 may cover the entireties or substantially the entireties of the second connection portion 55, the second side surface band portion 58, and the fourth side surface band portion 59.

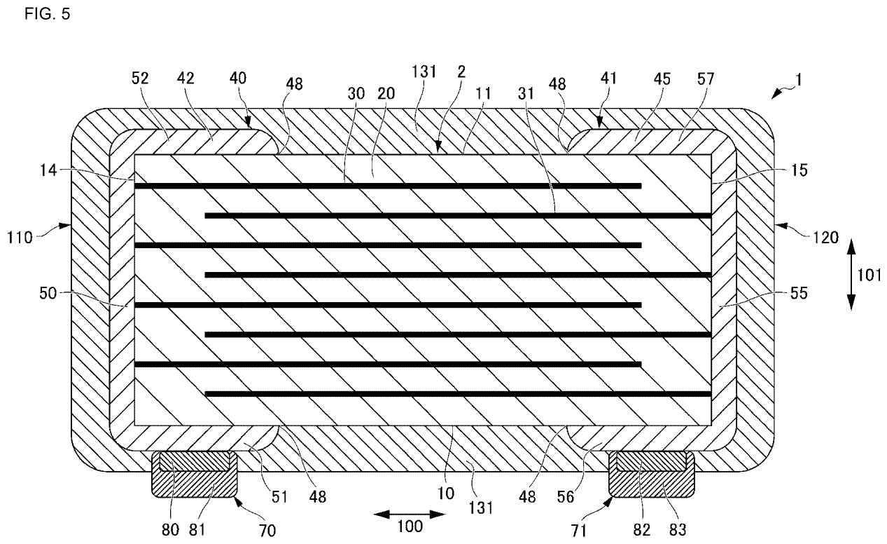

An insulating layer in another structure is described with reference to FIG. 5. FIG. 5 is a diagram of a multilayer ceramic capacitor 1 with another structure. FIG. 5 is a cross section of the multilayer ceramic capacitor 1 taken along a plane parallel or substantially parallel to the length direction 100 and the height direction 101.

As illustrated in FIG. 5, the first insulating layer 110 may further cover the first main surface band portion 51, at least a portion of the first main surface 10, the third main surface band portion 52, and at least a portion of the second main surface 11. The second insulating layer 120 may further cover the second main surface band portion 56, at least a portion of the first main surface 10, the fourth main surface band portion 57, and at least a portion of the second main surface 11.

In other words, the first insulating layer 110 may continuously cover the first main surface band portion 51, at least a portion of the first main surface 10 exposed on the surface of the multilayer ceramic capacitor 1, the third main surface band portion 52, and at least a portion of the second main surface 11 exposed on the surface of the multilayer ceramic capacitor 1, in addition to the first and third side surface band portions, and portions or entireties of the first side surface 12 and the second side surface 13. The second insulating layer 120 may continuously cover the second main surface band portion 56, at least a portion of the first main surface 10 exposed on the surface of the multilayer ceramic capacitor 1, the fourth main surface band portion 57, and at least a portion of the second main surface 11 exposed on the surface of the multilayer ceramic capacitor 1, in addition to the second and fourth side surface band portions, and portions or entireties of the first side surface 12 and the second side surface 13.

In this case, preferably, the first insulating layer 110 may entirely or substantially entirely cover the first connection portion 50, the first main surface band portion 51, and the third main surface band portion 52. The second insulating layer 120 may entirely or substantially entirely cover the second connection portion 55, the second main surface band portion 56, and the fourth main surface band portion 57.

In the insulating layer with this structure, the first side surface band portion 53, the second side surface band portion 58, the third side surface band portion 54, the fourth side surface band portion 59, the first side surface 12, and the second side surface 13 are covered with the first or second insulating layer. Thus, bonding strength between the side surface band portions and the multilayer body is improved. This structure can thus reduce or prevent detachment from the side surface band portions or water infiltration.

When the insulating layers cover the entireties or substantially the entireties of the side surface band portions and the connection portions, the side surface band portions and the connection portions are not exposed, and surface deterioration of the side surface band portions and the connection portions can be reduced or prevented.

In the structure where the insulating layers also cover portions of the main surface band portions and the main surfaces continuously, in addition to the bonding strength between the side surface band portions and the multilayer body 2, the bonding strength between the main surface band portions and the multilayer body 2 is improved. This structure can reduce or prevent detachment from the side surface band portions and the main surface band portions or water infiltration. In other words, this structure improves bonding strength between each of the first base electrode layer 42 and the second base electrode layer 45 and the multilayer body 2, and reduces or prevents detachment between each of the first base electrode layer 42 and the second base electrode layer 45 and the multilayer body 2 or water infiltration. When the main surface band portions, the side surface band portions, and the connection portions are entirely or substantially entirely covered, the first base electrode layer 42 and the second base electrode layer 45 are not exposed, and thus surface deterioration of the first base electrode layer 42 and the second base electrode layer 45 can be reduced or prevented.

The first insulating layer 110 and the second insulating layer 120 may be coupled on the first side surface 12 and the second side surface 13. Preferably, the first insulating layer 110 and the second insulating layer 120 may be coupled on the entireties or substantially the entireties of the first side surface 12 and the second side surface 13 exposed on the multilayer ceramic capacitor 1. In other words, the first insulating layer 110 and the second insulating layer 120 may cover the side surfaces.

When the first insulating layer 110 and the second insulating layer 120 are coupled on the first side surface 12 and the second side surface 13, during mounting, solder is reliably prevented from wetting up to the first side surface band portion 53, the second side surface band portion 58, the third side surface band portion 54, and the fourth side surface band portion 59, in addition to the first connection portion 50 and the second connection portion 55. This structure thus effectively reduces noise.

The first insulating layer 110 and the second insulating layer 120 may be coupled on the first main surface 10, the second main surface 11, the first side surface 12, and the second side surface 13. More preferably, the first insulating layer 110 and the second insulating layer 120 may be coupled on the first side surface 12 and the second side surface 13 exposed on the multilayer ceramic capacitor and the entireties or substantially the entireties of the first main surface 10 and the second main surface 11 exposed on the multilayer ceramic capacitor.

Portions where the first insulating layer 110 and the second insulating layer 120 are coupled on the first main surface 10 and the second main surface 11, or the first side surface 12 and the second side surface 13 are referred to as insulating layer coupling portions 131. FIG. 5 illustrates the insulating layer coupling portions 131 on the first main surface 10 and the second main surface 11.

In this structure, the entireties or substantially the entireties of the first base electrode layer 42 and the second base electrode layer 45 are covered with an insulating layer, and this structure can thus reduce or prevent surface deterioration of the base electrode layers. In addition, the entireties or substantially the entireties of the first main surface 10, the second main surface 11, the first side surface 12, and the second side surface 13 are covered with an insulating layer. Thus, detachment of each of the first base electrode layer 42 and the second base electrode layer 45 from the multilayer body 2 is significantly reduced or prevented, and a water infiltration path between each of the first base electrode layer 42 and the second base electrode layer 45 and the multilayer body 2 is significantly reduced or prevented. This structure thus significantly improves waterproof reliability.

The material of the insulating layers is described below. The material of the first insulating layer 110 and the second insulating layer 120 is not limited to a particular material. The material of the insulating layers may be, for example, a synthetic resin. Examples of a synthetic resin include a thermosetting resin such as epoxy resin, polyimide resin, or phenol resin, a thermoplastic resin such as polyethylene resin or polyamide resin, or a photo-curable resin that causes polymerization reaction in response to light such as ultraviolet rays or visible light to cure.

More preferably, the material of the first insulating layer 110 and the second insulating layer 120 may include an inorganic material such as, for example, alumina, silica, glass, or ceramics in the synthetic resin described above.

Adding any of alumina, silica, glass, or ceramics to the insulating layer reduces the resin content in the insulating layer, and thus can reduce the amount of water absorption. In addition, reduction of residual stress of the insulating layer caused at the interface between itself and an element and reduction of a coefficient of linear expansion can effectively improve adhesion.

The dimensions of the multilayer ceramic capacitor 1 are not limited to particular dimensions. The multilayer ceramic capacitor 1 may have, for example, a dimension in the height direction 101 greater than or equal to about 0.1 mm and less than or equal to about 2.5 mm, a dimension in the length direction 100 greater than or equal to about 0.1 mm and less than or equal to about 3.2 mm, and a dimension in the width direction 102 greater than or equal to about 0.1 mm and less than or equal to about 2.5 mm.

An example of a method for manufacturing the multilayer ceramic capacitor 1 is described below.

First, a dielectric substance sheet and internal-electrode-dedicated electroconductive paste are prepared. The dielectric substance sheet and the internal-electrode-dedicated electroconductive paste contain a binder and a solvent, which may be a known organic binder or a known organic solvent.

Thereafter, a predetermined pattern is printed on a dielectric substance sheet with the internal-electrode-dedicated electroconductive paste by, for example, screen printing or gravure printing, and thus an internal electrode pattern is formed.

In addition, a predetermined number of dielectric substance sheets for outer layers on which no internal electrode pattern is formed are laminated, a dielectric substance sheet on which an internal electrode is formed is sequentially laminated, and a predetermined number of dielectric substance sheets for outer layers are laminated on the dielectric substance sheets to fabricate a multilayer sheet.

The multilayer sheet thus obtained is pressed in the height direction 101 by a method such as, for example, isostatic pressing to fabricate a multilayer block.

The multilayer block is then cut into a predetermined size to form multilayer chips. At this time, the corner portions and the ridge portions of each multilayer chip may be rounded by, for example, barrel polishing.

Each multilayer chip is fired to fabricate the multilayer body 2. Although depending on the material of the dielectric substance or the internal electrode, the firing temperature at this time is preferably, for example, greater than or equal to about 900 °C and less than or equal to about 1300 °C.

Outer-electrode-dedicated electroconductive paste is applied to both end surfaces of the obtained multilayer body 2, and fired to form fired layers of the outer electrodes. The firing temperature at this time is preferably, for example, greater than or equal to about 700 °C and less than or equal to about 900 °C.

An example of a method for manufacturing spacer portions and insulating layers is described below. The method for manufacturing spacer portions and insulating layers includes two patterns. A first pattern is to form the spacer portions earlier than the insulating layers. A second pattern is to form the spacer portions later than the insulating layers. These patterns are sequentially described below.

First, a pattern to form the spacer portions earlier than the insulating layers is described.

An area where no spacer portion is to be formed and from which t base electrode layer is exposed is sealed with, for example, an adhesive tape to prevent a plating solution to infiltrate between the adhesive tape and the base electrode layer. Thereafter, for example, nickel plating and tin plating are sequentially performed using a nickel plating solution and a tin plating solution to form spacer portions with a predetermined thickness. The thickness of the spacer portions is adjustable as appropriate by changing the time for which the chip is immersed in the nickel plating solution or the tin plating solution or changing the electric current.

An insulating layer material is applied to the chip fabricated with the processes described above at insulating layer forming positions. At this time, as described above, the main component of the insulating layer material is not limited to a particular material, but may be, for example, thermosetting resin, thermoplastic resin, or photo-curable resin. In the present example embodiment, thermosetting resin is used as the insulating layer material, and the insulating layer material is applied to the insulating layer forming positions, that is, the base electrode layers where no spacer portion is formed, the main surfaces exposed on the surfaces of the multilayer body, the side surfaces, and the boundary between the surfaces. Polymerization reaction is then activated with heat to cure the insulating layer material. Although the above manufacturing method is performed in the present example embodiment, the insulating layers can be formed at various positions by changing the positions at which, for example, an adhesive tape is attached or at which the insulating layer material is applied. The insulating layer material can also be changed. For example, the insulating layer material can be changed into a solution obtained by mixing an inorganic material such as alumina, silica, glass, or ceramics into a main component formed from a monomer such as thermosetting resin, thermoplastic resin, or photo-curable resin. In this case, a curing resin method may be changed to involve, for example, heat or light radiation as appropriate.

Subsequently, a pattern to form spacer portions later than the insulating layers is described.

A chip fabricated by the processes described above is placed on an adhesive sheet, and an insulating layer material is applied to the chip. Thus, the insulating layer material is not applied to the portion where the adhesive sheet and the chip are in contact, and is selectively applied to other areas. At this time, as described above, the main component of the insulating layer material is not limited to a particular material, but may be, for example, thermosetting resin, thermoplastic resin, or photo-curable resin. In the present example embodiment, thermosetting resin is used as the insulating layer material, and the insulating layer material is applied to the insulating forming positions, that is, the base electrode layers where no spacer portion is formed, the main surfaces exposed on the surfaces of the multilayer body, the side surfaces, and the boundary between the surfaces. Polymerization reaction is then activated with heat to cure the insulating layer material. Thereafter, the adhesive sheet bonded to the chip is removed.

Although the above-described manufacturing method is performed in the present example embodiment, for example, the insulating layers can be formed at various positions by changing the positions at which, for example, the adhesive sheet and the chip are in contact or at which the insulating layer material is applied. The insulating layer material can also be changed. For example, the insulating layer material can be changed into a solution obtained by mixing an inorganic material such as alumina, silica, glass, or ceramics into a main component formed from a monomer such as thermosetting resin, thermoplastic resin, or photo-curable resin. In this case, a curing resin method may be changed to include, for example, heat or light radiation as appropriate.

As another method, the insulating layer forming position is adjusted using, for example, an adhesive tape. In a chip fabricated by the processes described above, the area where no insulating layer is formed is sealed with, for example, an adhesive tape or an adhesive sheet, and the insulating layer material is applied to the insulating layer forming position. Thus, the insulating layer material can be selectively applied to the area where the insulating layer is to be formed.

Nickel plating and tin plating, for example, are sequentially performed on the chip on which the insulating layers are formed in the process described above using a nickel plating solution and a tin plating solution to form spacer portions with a predetermined thickness at portions to which no insulating layer is applied and on which the base electrode layer is exposed. The thickness of the spacer portions is adjustable as appropriate by changing the time for which the chip is immersed in the nickel plating solution or the tin plating solution or changing the electric current.

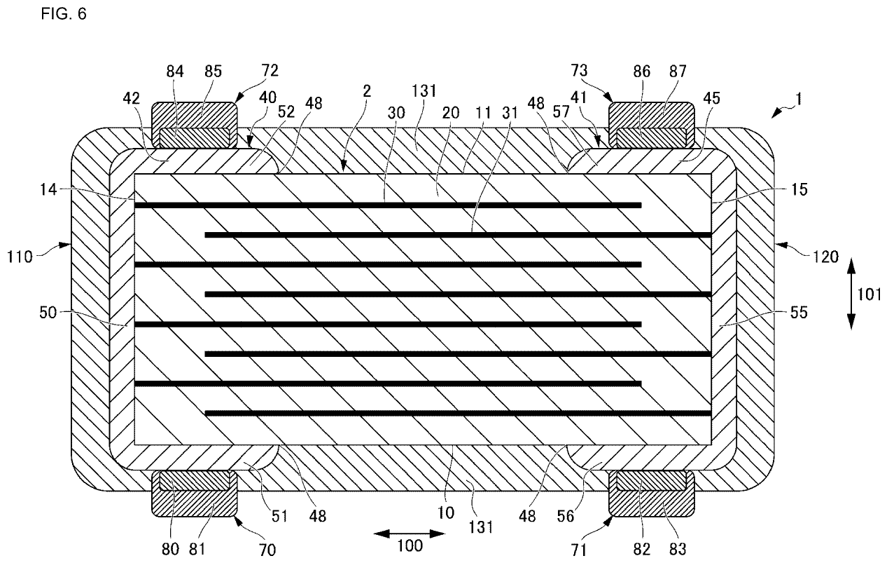

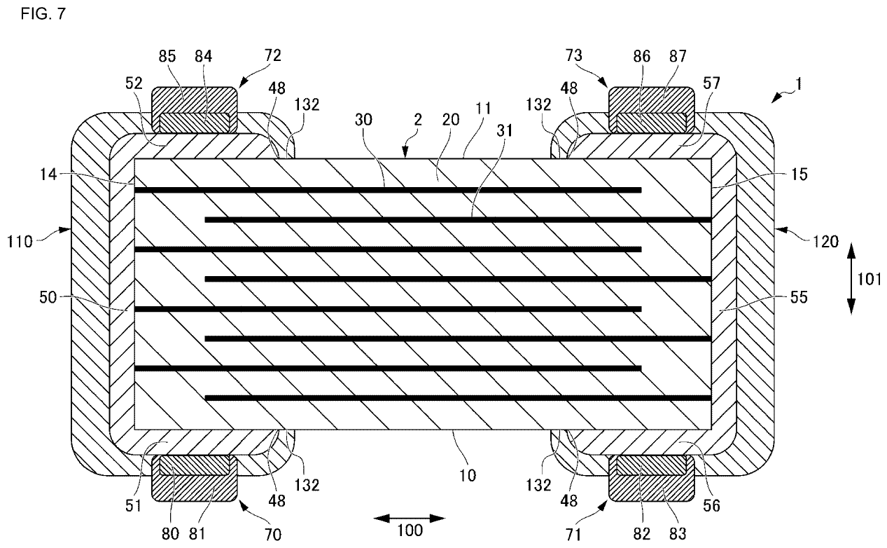

With reference to FIG. 6 and FIG. 7, the multilayer ceramic capacitor 1 according to a second example embodiment of the present invention is described. In the description provided below, portions different from those in the first example embodiment are mainly described. FIG. 6 and FIG. 7 are cross sections of the multilayer ceramic capacitor 1, taken along a plane parallel or substantially parallel to the length direction 100 and the height direction 101.

The multilayer ceramic capacitor 1 illustrated in FIG. 6 is described. The ceramic capacitor 1 illustrated in FIG. 6 differs from the multilayer ceramic capacitor 1 illustrated in FIG. 5 in terms of the positions of the spacer portions. The multilayer ceramic capacitor 1 illustrated in FIG. 5 includes two spacer portions, that is, the first spacer portion 70 and the second spacer portion 71, at positions closer to the first main surface 10. The multilayer ceramic capacitor 1 illustrated in FIG. 6 includes, in addition to two spacer portions at positions closer to the first main surface 10, a third spacer portion 72 and a fourth spacer portion 73 at positions closer to the second main surface 11.

More specifically, in the multilayer ceramic capacitor 1 illustrated in FIG. 6, the first outer electrode 40 includes the first base electrode layer 42, the first spacer portion 70 disposed on the first main surface band portion 51 and formed from plating metal, and the third spacer portion 72 disposed on the third main surface band portion 52 and formed from plating metal. In the multilayer ceramic capacitor 1 illustrated in FIG. 6, the second outer electrode 41 includes the second base electrode layer 45, the second spacer portion 71 disposed on the second main surface band portion 56 and formed from plating metal, and the fourth spacer portion 73 disposed on the fourth main surface band portion 57 and formed from plating metal.

The multilayer ceramic capacitor 1 illustrated in FIG. 6 has a advantageous effect of facilitating mounting, in addition to an advantageous effect of reducing wetting of solder included in the multilayer ceramic capacitor 1 illustrated in FIG. 5. The spacer portions are disposed on two surfaces including the first main surface 10 and the second main surface 11. Thus, to mount the multilayer ceramic capacitor 1 on the mounting board, an operation of adjusting the orientation of the multilayer ceramic capacitor 1 is facilitated.

The multilayer ceramic capacitor 1 illustrated in FIG. 7 is described below. The multilayer ceramic capacitor 1 illustrated in FIG. 7 differs from the multilayer ceramic capacitor 1 illustrated in FIG. 6 in the positions of the insulating layers on the first main surface 10 and the second main surface 11. In the multilayer ceramic capacitor 1 illustrated in FIG. 6, the first insulating layer 110 and the second insulating layer 120 are coupled on the first main surface 10 and the second main surface 11. The insulating layer coupling portion 131 is disposed on the first main surface 10 and the second main surface 11. In the multilayer ceramic capacitor 1 illustrated in FIG. 6, the main surfaces are covered with the outer electrodes or the insulating layers.

In the multilayer ceramic capacitor 1 illustrated in FIG. 7, the first main surface 10 and the second main surface 11 include portions left without being covered with the insulating layers and from which the main surfaces are exposed. A portion of each insulating layer that covers the main surface exposed on the surface of the multilayer ceramic capacitor 1 is referred to as an insulating-layer main surface portion 132. As illustrated in FIG. 7, the insulating-layer main surface portions 132 cover the end portions 48 of the outer electrodes.

As in the multilayer ceramic capacitor 1 illustrated in FIG. 7 when the surface of the multilayer ceramic capacitor 1 includes an area where no insulating layer is disposed, the cost of the insulating layer material can be reduced.

For example, the spacer portions according to the second example embodiment may be the same or substantially the same as the spacer portions according to the first example embodiment in terms of shape, material, and dimensions.

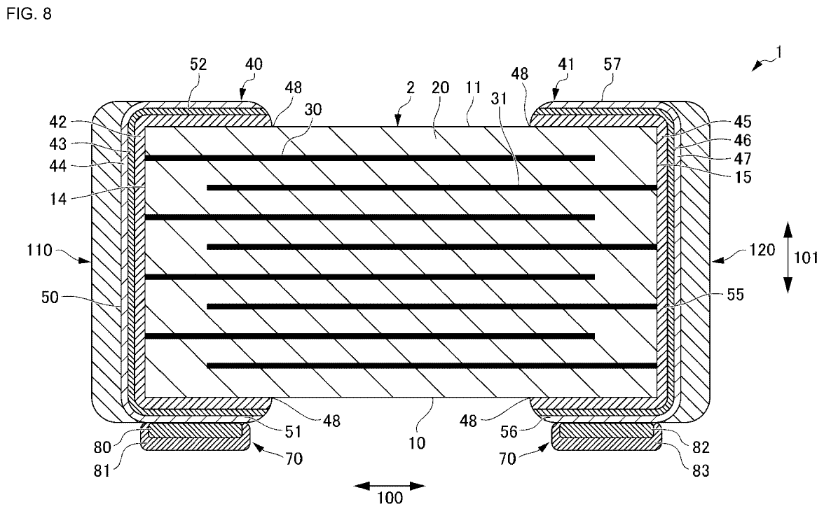

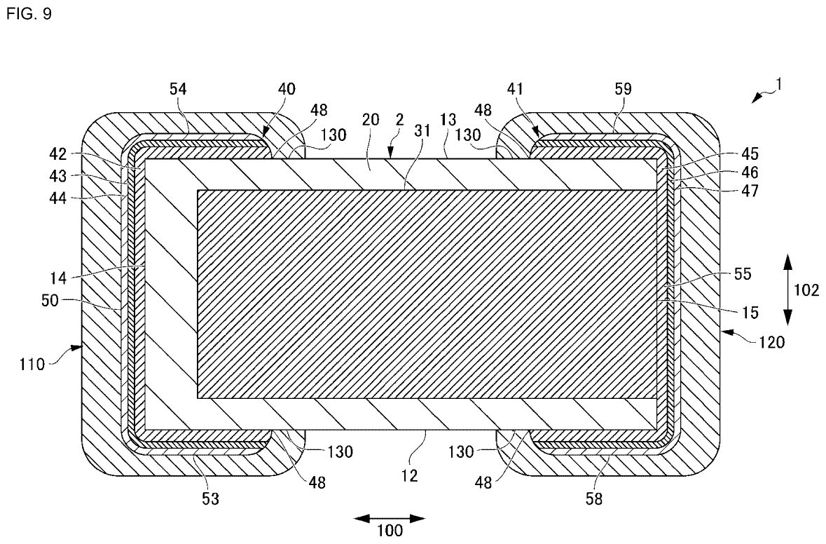

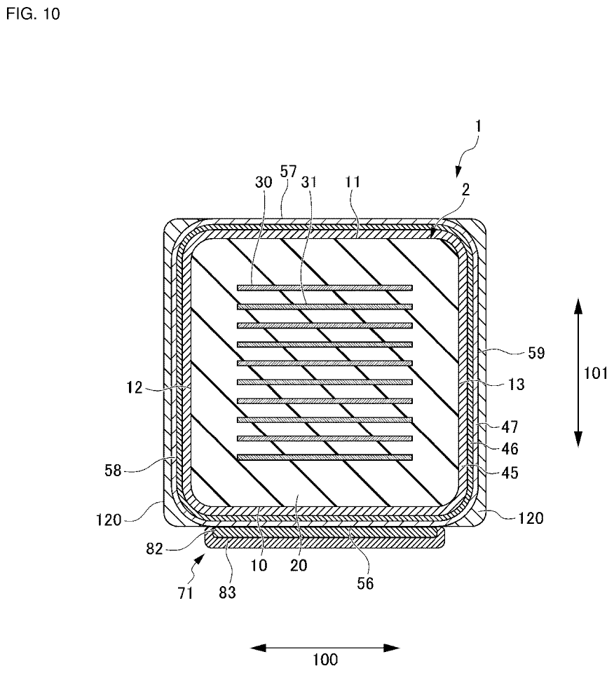

With reference to FIG. 8 to FIG. 10, outer electrodes according to modified examples of example embodiments of the present invention are described. FIG. 8 to FIG. 10 are diagrams of outer electrodes according to modified examples. FIG. 8 is a diagram corresponding to FIG. 2. FIG. 9 is a diagram corresponding to FIG. 3. FIG. 10 is a diagram corresponding to FIG. 4. In the description of the above example embodiments, each outer electrode includes a base electrode. In addition to the base electrode, the outer electrode may include a plating layer. Alternatively, the outer electrode may include multiple plating layers.

In the multilayer ceramic capacitor 1 illustrated in FIG. 8 to FIG. 10, the first outer electrode 40 includes a first plating layer 43 and a second plating layer 44, and the second outer electrode 41 includes a third plating layer 46 and a fourth plating layer 47. In the first outer electrode 40, the first base electrode layer 42, the first plating layer 43, and the second plating layer 44 are laminated in this order on the multilayer body 2. In the second outer electrode 41, the second base electrode layer 45, the third plating layer 46, and the fourth plating layer 47 are laminated in this order on the multilayer body 2.

The first plating layer 43 and the third plating layer 46 may be, for example, nickel plating layers. The second plating layer 44 and the fourth plating layer 47 may be, for example, tin plating layers.

The outer electrode including the plating layer can protect the surface of the outer electrode not covered with the insulating layers or the spacer portions against deterioration such as oxidation or corrosion.

The multilayer ceramic capacitor 1 according to each of the example embodiments described above has the advantageous effects described below. Solder generally has high wettability on metal, but low wettability on glass. Thus, solder has higher wettability on the plating layer than wettability on the base electrode layer. In example embodiments of the present invention, the spacer portions are disposed on the main surface band portions and formed from plating metal to thus form the plating layers on the first main surface, or on the first main surface and the second main surface. Thus, during mounting, solder wets up to the spacer portions disposed on the main surface band portions, but is less likely to wet up to the connection portions and the side surface band portions because the connection portions and the side surface band portions are physically spaced apart from the mount surface. Thus, in example embodiments of the present invention, solder is less likely to wet up to the connection portions and the side surface band portions. This structure can thus prevent an increase in solder wetting height in the height direction during mounting, and thus reduce noise generation. In addition, this structure includes the spacer portions formed from the plating layers, and thus does not involve an additional process. This structure can thus be manufactured using less complex processes at lower manufacturing costs.

In example embodiments of the present invention, the insulating layers are disposed on the outer electrode, particularly, on the side surface band portions and the connection portions of the base electrode layers. Thus, solder wettability on the side surface band portions and the connection portions of the base electrode layers can be more reliably reduced during mounting. The structure in example embodiments of the present invention can more reliably reduce an increase of solder wetting height on the side surface band portions and the connection portions of the base electrode layers in the height direction, and thus reduce noise generation.

Example embodiments of the present invention have been described above. The present invention is not limited to the example embodiments described above, and various modifications, variations, and combinations may be made.

In the example embodiments described above, the multilayer ceramic electronic component is a multilayer ceramic capacitor. The multilayer ceramic electronic component, however, is not limited to a multilayer ceramic capacitor. When a piezoelectric ceramic material is used as a material of the multilayer body, a multilayer ceramic electronic component defines and functions as a ceramic piezoelectric device. An example of the piezoelectric ceramic material is a lead-zirconate-titanate (PZT) ceramic material.

When a semiconductor ceramic material is used as a material of the multilayer body, the multilayer ceramic electronic component defines and functions as a thermistor device. An example of a semiconductor ceramic material is a spinel ceramic material.

When a magnetic ceramic is used as a material of the multilayer body, the multilayer ceramic electronic component defines and functions as an inductor device. When the multilayer ceramic electronic component defines and functions as an inductor device, the internal electrode defines and functions as a coil conductor. An example of a magnetic ceramic material is a ferrite ceramic material.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component, comprising:
a multilayer body including:
a first main surface and a second main surface opposite to each other in a height direction;
a first side surface and a second side surface opposite to each other in a width direction perpendicular or substantially perpendicular to the height direction;
a first end surface and a second end surface opposite to each other in a length direction perpendicular or substantially orthogonal to the height direction and the width direction;
a first internal electrode exposed on the first end surface; and
a second internal electrode exposed on the second end surface;
a first outer electrode connected to the first internal electrode; and
a second outer electrode connected to the second internal electrode; wherein the first outer electrode includes:
a first connection portion on the first end surface;
a first main surface band portion on the first main surface;
a third main surface band portion on the second main surface;
a first side surface band portion on a portion of the first side surface;
a third side surface band portion on a portion of the second side surface; and
a first spacer portion on the first main surface band portion;
the second outer electrode includes:
a second connection portion on the second end surface;
a second main surface band portion on the first main surface;
a fourth main surface band portion on the second main surface;
a second side surface band portion on a portion of the first side surface;
a fourth side surface band portion a portion of the second side surface; and
a second spacer portion on the second main surface band portion;
the first spacer portion is metal plating; and
the multilayer ceramic electronic component includes:
a first insulating layer continuously covering the first connection portion and the third side surface band portion.

2. The multilayer ceramic electronic component according to claim 1, wherein a dimension of the first spacer portion in the height direction is greater than or equal to about 5 μm and less than or equal to about 25 μm.

3. The multilayer ceramic electronic component according to claim 1, wherein the first insulating layer further covers the first main surface band portion.

4. The multilayer ceramic electronic component according to claim 3, wherein
the first insulating layer further covers at least a portion of the first main surface.

5. The multilayer ceramic electronic component according to claim 1, wherein
the first insulating layer includes at least one of alumina, silica, glass, ceramic, or thermosetting resin.

6. The multilayer ceramic electronic component according to claim 1, wherein
the first spacer portion includes:
a first nickel plating layer including nickel and connected to the first main surface band portion; and
a first tin plating layer including tin and covering the first nickel plating layer.

7. The multilayer ceramic electronic component according to claim 1, further comprising:
a third spacer portion on the third main surface band portion and including an electroconductive material; and
a fourth spacer portion on the fourth main surface band portion and including an electroconductive material.

8. The multilayer ceramic electronic component according to claim 7, wherein
a dimension of the third spacer portion in the height direction is greater than or equal to about 5 μm and less than or equal to about 25 μm.

9. The multilayer ceramic electronic component according to claim 1, wherein
the first insulating layer further covers the third main surface band portion.

10. The multilayer ceramic electronic component according to claim 9, wherein the first insulating layer further covers at least a portion of the second main surface.

11. The multilayer ceramic electronic component according to claim 1, wherein
the multilayer ceramic electronic component includes:
a second insulating layer continuously covering the second connection portion and the fourth side surface band portion.

12. The multilayer ceramic electronic component according to claim 7, wherein
the third spacer portion includes:
a third nickel plating layer including nickel and connected to the third main surface band portion; and
a third tin plating layer including tin and covering the third nickel plating layer.

13. The multilayer ceramic electronic component according to claim 1, wherein the second spacer portion is metal plating.

14. The multilayer ceramic electronic component according to claim 7, wherein the third spacer portion and the fourth spacer portion are metal plating.

15. The multilayer ceramic electronic component according to claim 1, wherein
the first outer electrode includes a first base electrode layer including an electroconductive metal and glass.

16. The multilayer ceramic electronic component according to claim 15, wherein
the first outer electrode includes a first plating layer and a second plating layer;
the first base electrode layer, the first plating layer, and the second plating layer are laminated on the multilayer body in an order of the first base electrode layer, the first plating layer, and the second plating layer;
the first plating layer is a nickel plating layer; and
the second plating layer is a tin plating layer.

17. The multilayer ceramic electronic component according to claim 11, wherein the second insulating layer further covers the second main surface band portion.

18. The multilayer ceramic electronic component according to claim 17, wherein the second insulating layer further covers the at least a portion of the first main surface.

19. The multilayer ceramic electronic component according to claim 11, wherein the second insulating layer further covers the fourth main surface band portion.

20. The multilayer ceramic electronic component according to claim 19, wherein the second insulating layer further covers at least a portion of the second main surface.
